(19) United States
(12) Patent Application Publication
(10) Pub. No.: US 2010/0278544 A1
(43) Pub. Date: Nov. 4, 2010

(54) SYSTEM AND METHOD FOR ENSURING THAT ONLY A SPECIFIC TONER IS USED FOR PRINTING A DOCUMENT

(75) Inventor: Joseph J. Pfeuffer, Oakdale, PA (US)

Correspondence Address: SNELL & WILMER LLP (OC), 600 ANTON BOULEVARD, SUITE 1400, COSTA MESA, CA, 92626, US

(73) Assignee: Troy Group, Inc., Costa Mesa, CA (US)

(21) Appl. No.: 12/432,695

(22) Filed: Apr. 29, 2009

(51) Int. Cl. G03G 15/00

(52) U.S. Cl. 399/12

(57) ABSTRACT

The present invention relates to a system and method for ensuring that a correct toner is used for printing a document. A printer receives data about a document requiring a specific toner type to print the document. The printer receives toner type identification from a toner cartridge inserted into the printer. The specific toner type required is compared with the available toner type in the cartridge. If the available toner type in the cartridge matches the specific toner type, the document is printed. If there is no match, the printer displays an error message and does not print the document.

### BACKGROUND OF THE INVENTION

1. Field of the Invention

The present invention relates to a system and method for ensuring that only a correct toner is used for printing a document.

2. Description of Related Art

Some specialty documents need to be printed with specialty toners. However, specialty toners are expensive. There is a tendency to use the specialty toner even when the specialty toners are not required just because they are in the printer. The swapping of toners can lead to conventional toners being accidentally used to print a specialty document and specialty toners being used to print a regular document. Specialty documents printed with a conventional toner are problematic: They are visually identical to documents printed with a specialty toner. A user may not detect that a specialty document was printed with the wrong type of toner.

If the error is not detected, the specialty document will be improperly processed. For example, if the specialty document is a check and magnetic ink character recognition (“MICR”) toner is not used, the check will be returned. An improperly printed check will prevent funds from being properly transferred and call into question the credit-worthiness of the entity issuing the checks.

Conventional toner cartridge identification systems typically only determine whether a toner cartridge is compatible with a printer. The conventional toner cartridge identification systems do not identify whether the toner cartridge contains the specific toner type required for a particular document, of which there may be many, each with a specific toner requirement. Thus, even when the toner cartridge identification system determines that the cartridge is compatible with the printer, the identification system will not prevent the printing of a document on that printer using the incorrect toner type.

There is an unresolved need for a system and method for ensuring that a correct toner out of many available toners is used for printing a document, requiring a specific toner out of many available toners.

### SUMMARY OF THE INVENTION

The present invention ensures that only the correct toner is used to print a document. A printer receives data about the specific toner type required to print the document. The printer receives toner type identification from a toner cartridge inserted into the printer. The specific toner type required is compared with the available toner type in the cartridge. If the available toner type in the cartridge matches the specific toner type, the document is printed. If there is no match, the printer displays an error message and does not print the document.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a block diagram of a printer that could use the present invention;

FIG. 2 is a flow chart of a printer system of the present invention;

FIG. 3 is a block diagram according to one embodiment of the present invention; and

FIG. 4 is a block diagram according to another embodiment of the present invention.

### DETAILED DESCRIPTION OF THE INVENTION

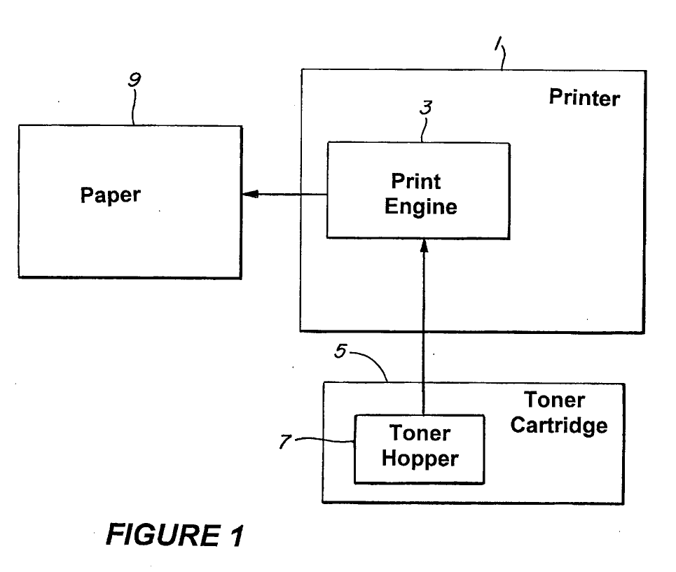

As seen in FIG. 1, when printing a document onto a sheet of paper 9, a printer 1 containing a print engine 3 receives toner from a toner cartridge 5 having a toner hopper 7. The print engine 3 deposits the toner onto the paper 9 to form the document.

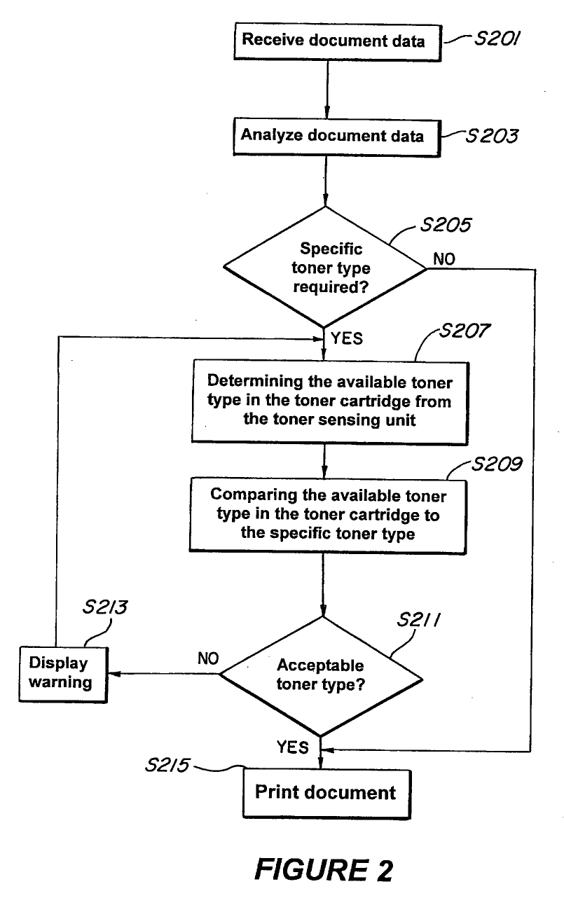

Referring now to FIG. 2, which shows the logic flow of the present invention. At S201, data identifying a type of document to be printed is received. The document data includes information about the specific toner type required to print the document. The toner types can be, for example a magnetic ink character recognition (“MICR”) toner, a security toner, or a regular toner, or other equivalent. At S203, the processor 15 analyzes the document data to determine whether a specific toner type is required to print the document. At S205, if a specific toner is not required, the system proceeds directly to print at S215.

At S205, if a specific toner is required, at S207, the toner type available is determined. At S209, the system compares the toner type available with the specific toner type required. At S211, the system determines whether the toner type available matches the specific toner type.

At S213, if the toner type available does not match the specific toner type required at S211, the system displays an error message indicating that the wrong toner type is used. Steps S207, S209, and S211 are repeated until the toner type available matches the specific toner type required. At S215, if the toner type available matches the specific toner type required at S211, the system prints the document.

Advantageously, by only printing the document when the correct toner type is in the printer, incorrectly printed documents are entirely avoided.

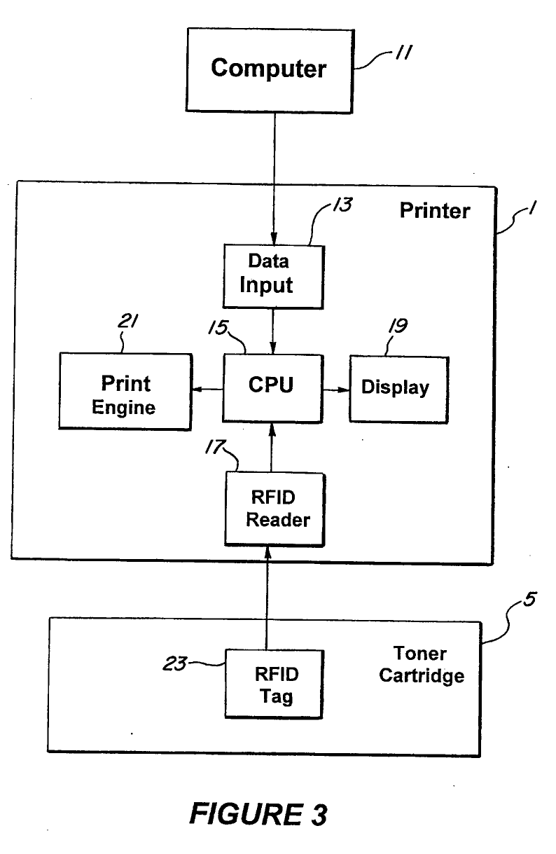

As seen in FIG. 3, a data input unit 13 receives the document data representing a type of document from a computer 11 and transmits the document data to a processor 15. The processor 15 analyzes the document data to determine what toner type is required to print the next document. If a specific toner type is not required, the processor 15 instructs the print engine 21 to print the document.

If a specific toner type is required, the processor 15 determines the toner type in the toner cartridge 5. To determine the toner type in the toner cartridge 5, a radio-frequency identification (“RFID”) tag 23 in toner cartridge 5 transmits toner identification data to an RFID reader 17. The RFID tag 23 can be mounted anywhere on the toner cartridge 5. The RFID tag 23 can be, for example, a passive RFID tag or an active RFID tag. The RFID reader 17 transmits the toner identification data to the processor 15.

The toner identification data can be, for example, a serial number unique to the toner type. For example, a conventional toner type may have a first serial number. A MICR toner type may have a second different serial number. A security toner type may have a third different serial number. Thus, based on the toner identification data, the processor 15 can distinguish between many different types of toner types and determine which toner type is available in the toner cartridge 5.

If the available toner type does not match the specific toner type required, the processor 15 displays an error message on a display 19 indicating that a wrong toner type is in the printer. The error message may also indicate the specific toner type required and the currently available toner in the cartridge 5. If the available toner type matches the specific toner type required, the processor 15 transmits instructions to the print engine 21 to print the document.

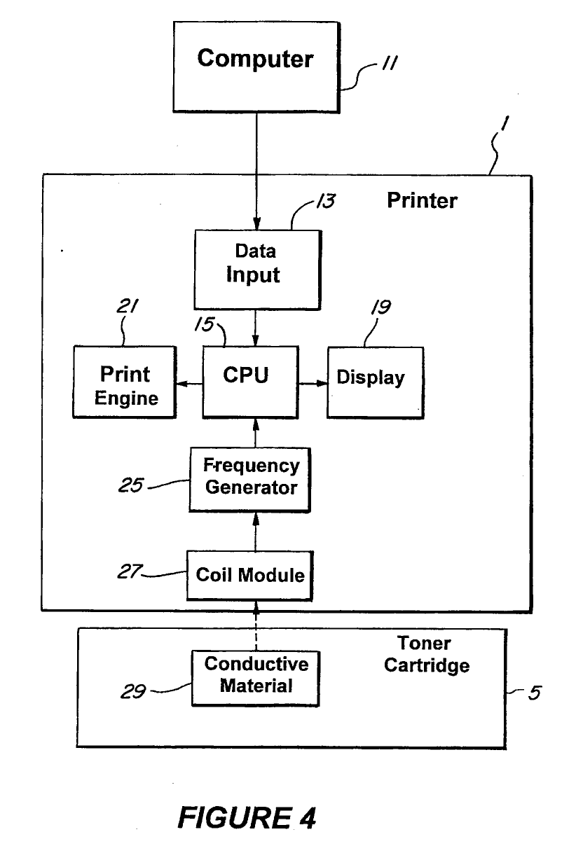

In another embodiment disclosed in FIG. 4, the printer 1 has a frequency generator 2 and a coil module 27. The toner cartridge 5 includes a magnetic material 29 which can be moved into proximity with the coil module 27. Frequency data is generated from the frequency generator 25 based on the inductance of the coil module 27. The magnetic material can be any type of material which would alter the inductance of the coil module 27 thereby changing the frequency data generated by the frequency generator 25.

The magnetic material 29 is moved into printing with the coil module 27 when the toner cartridge 5 is inserted into the printer 1. The frequency data generated by the frequency generator 25 is altered when the magnetic material 29 is in the proximity of the coil module 27. The frequency data generated by the frequency generator 25 depends on the surface area of the magnetic material 29 and the location of the magnetic material 29 in relation to the coil module 27.

Each toner type will have a corresponding unique frequency signature. For example, a conventional toner type may have a first frequency signature. A MICR toner type may have a second different frequency signature. A security toner type may have a third different frequency signature. Thus, based on the frequency data, the processor 15 can distinguish between many different toner types and determine which toner type is available to the printer 1.

What is claimed is:

1. A method for printing a document in a printer using toner cartridges, the method comprising the steps of:
receiving data representing a type of toner needed to print a document;
determining the kind of toner available for printing the document;
comparing the toner available to the toner needed; and
only printing the document when the available toner matches the toner type needed.

2. The method of claim 1 further comprising the step of displaying a warning when the available toner does not match the toner needed.

3. The method of claim 1 wherein the step of determining the toner available comprises, receiving toner identification data from an identification reader in the printer.

4. The method of claim 3 wherein the step of determining the toner type available comprises, transmitting toner identification data from an identification tag on the toner cartridge to the identification reader.

5. The method of claim 1 wherein the step of determining the toner available comprises:
receiving frequency data from a frequency generator in the printer; and
determining the toner available based on the frequency data.

6. The method of claim 5 wherein the step of determining the toner available comprises, changing the frequency of the inductance generator, in response to a change in the type of toner available.

7. The method of claim 6 wherein the step of changing the frequency of the frequency generator comprises, changing the frequency of a coil module in the frequency generator.

8. A printer system having a printer, comprising:
an input unit for receiving data representing the type of toner required for printing a document;
a toner cartridge for insertion into the printer, the cartridge including an identification unit for providing toner identification;
a toner sensing unit in the printer for sensing the toner identification;
a processor for determining whether the toner in the cartridge matches the toner required; and
a print engine for printing the document only when the toner in the cartridge matches the toner required.

9. The printer system of claim 8 further comprising a display for displaying an error message when the toner in the cartridge does not match the toner required.

10. The printer system of claim 8 wherein the identification unit on the toner cartridge is an RFID tag.

11. The printer system of claim 10 wherein the RFID tag is a passive RFID tag.

12. The printer system of claim 8 wherein the toner sensing unit in the printer is an RFID reader.

13. The printer system of claim 8 wherein the identification unit on the toner cartridge is a magnetic material.

14. The printer system of claim 8 wherein the toner sensing unit in the printer comprises a frequency generator.

15. The printer system of claim 14 wherein the toner sensing unit in the printer comprises a coil module.

16. A printer using a toner cartridge having toner identification, comprising:
an input unit for receiving data representing the type of toner required for printing a document;
an RFID reader in the printer for sensing the toner identification;
a processor for determining whether the toner in the cartridge matches the toner required; and
a print engine for printing the document only when the toner in the cartridge matches the toner required.

17. The printer of claim 16 further comprising, a display for displaying an error message when the toner in the cartridge does not match the specific toner required.

18. A printer using a toner cartridge having toner identification, comprising:
an input unit for receiving data representing the type of toner required for printing a document;
a frequency generator in the printer for sensing the toner identification;
a processor for determining whether the toner in the cartridge matches the toner required; and
a print engine for printing the document only when the toner in the cartridge matches the toner required.

19. The printer of claim 18 further comprising a coil module in the frequency generator.

20. The printer of claim 18 further comprising, a display for displaying an error message when the toner in the cartridge does not match the specific toner required
